(19) United States
(12) Patent Application Publication
(10) Pub. No.: US 2021/0323819 A1
(43) Pub. Date: Oct. 21, 2021

(54) PROCESS AND APPARATUS FOR REMOVAL OF METAL CARBONYLS FROM A GAS MIXTURE

(71) Applicant: L'Air Liquide, Société Anonyme pour l'Etude et l'Exploitation des Procédés Georges Claude, Paris (FR)

(72) Inventors: Sharon CORBET, Frankfurt (DE); Alfred GUBRINSKI, Frankfurt am Main (DE); Sophia SCHMIDT, Frankfurt am Main (DE)

(21) Appl. No.: 17/273,174

(22) PCT Filed: Aug. 13, 2019
(86) PCT No.: PCT/EP2019/025270

§ 371 Date: Mar. 3, 2021

(30) Foreign Application Priority Data
Sep. 3, 2018 (EP) EP18020424

(51) Int. Cl. C01B 3/52; C01B 17/16; C01B 17/04; B01D 53/14; B01D 53/18; B01D 53/52; B01D 53/64; B01D 53/72; B01D 53/78

(52) U.S. Cl. CPC C01B 3/52; B01D 2257/706; C01B 17/0408; B01D 53/1493; B01D 53/1425; B01D 53/1418; B01D 53/1487; B01D 53/18; B01D 53/526; B01D 53/64; B01D 53/72; B01D 53/78; C01B 2203/0415; C01B 2203/0485; B01D 2252/2021; B01D 2256/16; B01D 2256/20; B01D 2257/304; B01D 2257/504; C01B 17/165

(57) ABSTRACT

The invention relates to a process for removal of metal carbonyl from a gas mixture. The gas mixture is subjected to a gas scrubbing in an absorber with methanol as the physical scrubbing liquid to obtain the laden methanol. The metals of the metal carbonyls are at least partially precipitated from the laden methanol as metal sulfides to obtain a first suspension comprising metal sulfides and at least a proportion of the laden methanol. The first suspension is sent to a treatment vessel and therein brought into direct contact with water vapor in countercurrent to obtain a second suspension comprising at least water, methanol and metal sulfides and a gaseous product. The second suspension and the gaseous product are withdrawn from the treatment vessel as separate streams.

### CROSS REFERENCE TO RELATED APPLICATIONS

This application is a 371 of PCT/EP2019/025270, filed Aug. 13, 2019, which claims priority to EP 18020424, filed Sep. 3, 2018, the entire contents of which are incorporated herein by reference.

### BACKGROUND

### Technical Field of the Invention

The invention relates to a gas scrubbing process for removal of metal carbonyls from a gas mixture in which metal carbonyls are at least partially precipitated from the laden methanol as metal sulfides. The invention further relates to an apparatus for performing such a process and to the use of the process or of the apparatus in a gas scrubbing process with methanol as the scrubbing liquid.

### Prior Art

Processes for removal of undesired concomitants from industrial crude gases by physical or chemical absorption are known from the prior art. Thus such processes may be used to remove down to trace amounts unwanted, acidic constituents of crude synthesis gases produced by gasification or reforming of carbon-containing inputs, for example carbon dioxide (CO₂) and hydrogen sulfide (H₂S) but also carbonyl sulfide (COS) and hydrogen cyanide (HCN), from the wanted synthesis gas constituents such as hydrogen (H₂) and carbon monoxide (CO).

A known and often employed process is the Rectisol process. In the Rectisol process the abovementioned unwanted disruptive components are absorbed by cold methanol, i.e. methanol cooled significantly below ambient temperature, as an absorbent or scrubbing medium, wherein intensive mass transfer between the crude gas and the absorbent/scrubbing medium takes place in an absorber column also known as an absorber or scrubbing column. The solubility of the unwanted gas constituents increases drastically with decreasing temperature of the methanol and increasing pressure while remaining practically constant for hydrogen and carbon monoxide. Methanol additionally has the advantage of retaining a low viscosity even at temperatures down to −75° C., thus making it usable on a large industrial scale even at low temperatures.

The production of synthesis gas from fuels comprising metallic trace components forms metal carbonyls which can impair the use of synthesis gas in a multiplicity of chemical production processes. The metal carbonyls are complexes in which carbon monoxide (CO) is coordinatively bonded to a metal atom. The metal carbonyls are in particular nickel carbonyls, for example tetracarbonylnickel(0) ([Ni(CO)₄]), and iron carbonyls, for example pentacarbonyliron(0) ([Fe(CO)₅]). Especially when using physical scrubbing agents such as methanol metal carbonyls can lead to problems during regeneration of the scrubbing agent, for example during hot regeneration, since metal carbonyls react with hydrogen sulfide (H₂S) present in the laden scrubbing medium to afford metal sulfides preferentially in hot regions of a gas scrubbing plant. The underlying equilibrium reaction is also driven by the poor solubility of the metal sulfides which are removed from the reaction equilibrium by precipitation, such as for example as shown by the reaction between pentacarbonyliron(0) and hydrogen sulfide (H₂S) to afford iron(II) sulfide, carbon monoxide and hydrogen

Fe(CO)₅+H₂S [symbol] FeS⬇+5CO+H₂

Since metal sulfides are poorly soluble to insoluble in practically all commonly used solvents all metal carbonyl- and hydrogen sulfide-containing crude synthesis gases in the gas scrubbing process suffer from the problem that through deposits metal sulfides can result in obstructions and blockages in the affected plant parts.

For removal of metal carbonyls WO 98/47602 provides a process in which by removal of carbon monoxide, for example by stripping from the scrubbing medium, the above equilibrium reaction is shifted to the side of the metal sulfides, thus bringing about an intentional precipitation of the metal sulfides out of the scrubbing medium. To this end the laden scrubbing medium is decompressed into a decompression vessel, thus releasing a decompression gas that also contains carbon monoxide (CO). The scrubbing medium depleted by a certain amount of CO is subsequently transferred into a reaction and settling vessel in which according to the residence time in the vessel and the type of the metal the metal carbonyls are largely completely removed from the scrubbing medium by precipitation as metal sulfides. The supernatant, the scrubbing medium largely freed of metal carbonyls, is subsequently sent to a hot regeneration.

The precipitate, the slurry containing metal sulfides or “sulfide slurry”, is subjected to further processing in a heated treatment vessel in which the scrubbing medium is in particular evaporated by an indirect heat exchanger and sent to a hot regeneration in which scrubbing medium is recovered while hydrogen sulfide in particular is also liberated from the laden scrubbing medium. The thus obtained hydrogen sulfide may be sent to a Claus plant for producing sulfur for example.

However the process for treatment of the sulfide slurry which is known from the prior art has the disadvantage that to generate the vaporous scrubbing medium from the sulfide slurry an indirect heat exchanger is used. Since employed indirect heat exchangers are typically tube bundle heat exchangers which have a large number of internals (tubes of the tube bundle, baffles), blockages in the internals of the tube bundle heat exchanger may easily occur as a result of adherent sulfides. The problem is intensified because metal sulfides, while present in pure methanol as a suspension, are present in finely dispersed form. It is known that methanol suspensions of metal sulfides therefore have a propensity for adhesion of the metal sulfides to metal surfaces of the affected plant component.

Furthermore, the process according to WO 98/47602 provides for the use of scrubbing water in respect of the sulfide sludge in the treatment vessel. This causes hydrogen cyanide (HCN) to be discharged from the treatment vessel with the scrubbing water and sulfide sludge as an undesired constituent. Due to the high toxicity of HCN this necessitates a further treatment of the sulfide sludge-containing wastewater. However it is desirable for the hydrogen cyanide present in the crude synthesis gas to exit the relevant plant with the hydrogen sulfide, also known as “Claus gas”, generated as a byproduct.

There is therefore a need for a process or an apparatus which in the workup of the sulfide sludge prevents sulfides adhering to metal surfaces and simultaneously avoids generation of toxic wastewaters.

### SUMMARY

The present invention accordingly has for its object to at least partially overcome the abovementioned disadvantages of the prior art.

It is a particular object of the present invention to specify a process which largely avoids the problems of metal sulfides precipitated from metal carbonyls adhering in plant components, in particular in indirect heat exchangers.

It is a further object of the present invention to specify a gas scrubbing process which largely avoids the generation of toxic wastewaters.

It is a further object of the present invention to specify an apparatus and/or a use which at least partially achieves the above objects.

The object of the invention is achieved by a process for removal of metal carbonyls from a gas mixture in which the gas mixture is subjected in an absorber to a gas scrubbing with methanol as the physical scrubbing liquid to obtain laden methanol and in which the metals of the metal carbonyls are at least partially precipitated from the laden methanol as metal sulfides to obtain a first suspension which comprises the metal sulfides and at least a proportion of the laden methanol and the first suspension is sent to a treatment vessel. According to the invention it is provided that the first suspension is brought into direct contact with water vapor in countercurrent in the treatment vessel to obtain a second suspension comprising at least water, methanol and metal sulfides and a gaseous product and the second suspension and the gaseous product are withdrawn from the treatment vessel as separate streams.

The first suspension contains the metal carbonyls from the gas mixture at least partially precipitated as metal sulfides and at least a proportion of the laden methanol. The gas mixture may be a crude synthesis gas which comprises at least the components hydrogen (H₂), carbon monoxide (CO), hydrogen sulfide (H₂S) and carbon dioxide (CO₂). The laden methanol is methanol laden with at least one gaseous component of the gas mixture, in particular the crude synthesis gas, in particular methanol laden with an acidic component, in particular methanol laden with hydrogen sulfide (H₂S) and/or carbon dioxide (CO₂).

The first suspension is brought into direct contact with water vapor in countercurrent in the treatment vessel. The terms “countercurrent” and “direct contact” are to be understood as meaning that the first suspension and the water vapor are run past one another in opposite directions according to the countercurrent principle so as to allow mass transfer and heat exchange between the first suspension and the water vapor. The direct contact between the first suspension and the water vapor allows mass transfer which would not be possible in the case of indirect content. The term “countercurrent” also includes processes where the countercurrent principle is at least partially realized, i.e. the first suspension in the treatment vessel is at least partially brought into direct contact with water vapor in countercurrent.

Components dissolved in the laden methanol are stripped by the water vapor to obtain a gaseous product withdrawn from the treatment vessel as a stream. Studies have shown that the sulfides present in the first suspension are largely transferred into the aqueous phase. This affords a second suspension which contains in particular water condensed from the water vapor, the metal sulfides and methanol, wherein the methanol comprises methanol regenerated by the water vapor.

The water present in the second suspension may comprise water condensed from the water vapor, wherein the water of the second suspension then at least partially comprises the water condensed from the water vapor. Additionally, the water of the second suspension may also contain water already entrained with the gas mixture, in particular the crude synthesis gas.

The water condensed from the water vapor is thus condensed especially by cooling by the laden methanol by direct heat exchange. Methanol is partially evaporated and withdrawn from the treatment vessel with the gaseous product as methanol vapor. The second suspension containing at least water, methanol and metal sulfides is withdrawn from the treatment vessel as a stream separate from the gaseous product. The term “separate streams” is to be understood as meaning that the two streams or material streams are in particular withdrawn from the treatment vessel as spatially separate streams so that no mass transfer between the withdrawn streams is possible.

The water vapor sent to the treatment vessel may also be referred to as direct steam, fresh steam or live steam.

The process according to the invention has the advantage that the use of water vapor in direct contact with the first suspension containing metal sulfides results in fewer deposits of sulfides in the treatment vessel and thus fewer blockages being caused. Studies have shown that a cleaning effect is achieved by the water vapor. This results in longer cleaning intervals and thus fewer shutdowns of the particular plant. The cleaning effect is predominantly based on the fact that particles of the metal sulfides exhibit different behavior in pure or in substantially pure methanol and in aqueous methanol solution. In pure methanol the particles of the metal sulfides are predominantly finely dispersed, i.e. have only a low sedimentation propensity. On the contrary when dispersed in pure methanol the particles have a propensity for adhesion to surfaces. By contrast, in aqueous methanol solution increasing water content results in agglomeration of smaller particles of the metal sulfides to afford larger aggregates which have a higher sedimentation propensity and a lower adhesion propensity. Another reason for this effect is that the metal sulfides are transferred into the aqueous phase upon contact with water vapor.

Aqueous methanol solution is to be understood as meaning any desired mixture of water and methanol. The aqueous methanol solution preferably has a water content of at least 5% by weight, particularly preferably a water content of at least 10% by weight, or 25% by weight, or 50% by weight, or 65% by weight.

A further advantage of the process according to the invention is that it does not require a special indirect heat exchanger for evaporating the methanol for hot regeneration. For the reasons above indirect heat exchangers may easily become blocked in particular when suspensions containing metal sulfides are pumped through them.

The laden methanol of the first suspension is stripped and thus regenerated by the direct contact with water vapor. The second suspension comprising the regenerated methanol may then be sent directly to a distillation column for methanol-water separation which is generally part of a corresponding gas scrubbing plant.

A further advantage of the process according to the invention is that the direct contacting of the first suspension with water vapor, or stripping of the first suspension with water vapor, also removes (gaseous) noxious substances such as hydrogen cyanide (HCN) from the first suspension so that treatment of HCN-contaminated wastewaters is not necessary. The hydrogen cyanide may be directly sent for further processing in conjunction with hydrogen sulfide likewise stripped out of the methanol of the first suspension as valuable gas present in the gaseous product, for example sent together with recovered hydrogen sulfide as Claus gas to a Claus plant for producing sulfur.

A preferred embodiment of the process according to the invention is characterized in that the first suspension comprising a proportion of the laden methanol is sent to the treatment vessel and the remainder of the laden methanol is sent to a regeneration, preferably sent to a hot regeneration.

It is preferable when the first suspension does not comprise the total amount of the methanol from which the metal carbonyls are precipitated as metal sulfides. On the contrary it has proven advantageous to be able to carry out the precipitation of the metal sulfides in an upstream residence time vessel for example, in particular a reaction and settling vessel, and subsequently to transfer only the sediment comprising the majority of the sulfides, also referred to as the precipitate, into the treatment vessel. The generally larger laden methanol amount of the supernatant is sent directly to an apparatus for regeneration, in particular an apparatus for hot regeneration. It is preferable when the proportion of the laden methanol present in the first suspension in the total amount of the laden methanol is less than 10% by weight, preferably less than 5% by weight or less than 3% by weight or less than 1% by weight.

A preferred embodiment of the process according to the invention is characterized in that the gaseous product comprises a mixture of hydrogen sulfide (H₂S) and methanol vapor.

When the laden methanol used for precipitation of the metal carbonyls as metal sulfides is withdrawn from the region of the absorber used primarily for desulfurization the gaseous product comprises a mixture of hydrogen sulfide (H₂S) and methanol vapor. The gaseous product always contains a certain amount of vaporous scrubbing medium, presently methanol vapor, formed by evaporation of the scrubbing medium upon direct contact of the first suspension with water vapor. The gaseous product containing hydrogen sulfide (H₂S) and methanol vapor is subsequently preferably sent to a multistage process for condensing out methanol. Subsequently, the gaseous product freed of methanol vapor which preferably now only comprises hydrogen sulfide can be sent to a Claus plant for producing sulfur.

A preferred embodiment of the process according to the invention is thus characterized in that methanol is condensed out of the methanol vapor of the gaseous product and the remaining hydrogen sulfide (H₂S) is sent to a Claus plant for further processing.

The laden methanol used for precipitating the metal carbonyls as metal sulfides may also be withdrawn from a region of the absorber used primarily for removal of hydrogen cyanide (HCN) and further trace constituents. The gaseous product then contains not only methanol vapor but also gaseous hydrogen cyanide. Likewise employable are combinations of both embodiments, the gaseous product therefore containing at least hydrogen sulfide, hydrogen cyanide and methanol vapor.

A preferred embodiment of the process according to the invention is characterized in that the gaseous product is withdrawn from a top region of the treatment vessel and/or the second suspension is withdrawn from a bottom region of the treatment vessel.

A top region is to be understood as meaning the upper region of the treatment vessel. The treatment vessel may be configured as a column, in particular as a so-called stripping column. A bottom region is to be understood as meaning the lower region of the treatment vessel or the column.

It is preferable when the water vapor is likewise supplied to the treatment vessel in a bottom region of the treatment vessel. The first suspension is preferably supplied to the treatment vessel in a top region of the treatment vessel to allow for the most intensive possible heat and mass transfer between the first suspension and the water vapor when run according to the countercurrent principle.

A preferred embodiment of the process according to the invention is characterized in that the second suspension is supplied to a distillation, in particular a countercurrent distillation, to obtain substantially pure methanol as the tops product and a mixture comprising substantially metal sulfides and water as the bottoms product. It is advantageous that due to the enrichment of water in the bottom of the methanol/water column the abovementioned advantageous behavior of the metal sulfide particles in contact with water occurs to an even greater extent.

The distillation is in particular a rectification for separating water and methanol. The pure methanol obtained in the distillation or rectification may subsequently be sent to a hot regeneration and then to the absorber for reloading. The bottoms product comprising substantially metal sulfides and water is sent for disposal. In this context the term “substantially” is to be understood as meaning that the proportion of the respective product or products is at least 95% by weight, preferably at least 99% by weight, particularly preferably at least 99.5% by weight.

A preferred embodiment of the process according to the invention is characterized in that the first suspension is supplied to the treatment vessel from at least one residence time vessel.

The residence time vessel preferably has a reaction and settling zone. Metal sulfides are formed in the reaction zone on account of the stripping of carbon monoxide (CO) effected in a preceding step and the prevailing temperature which promotes precipitation of the metal sulfides. In the settling zone the metal sulfides formed in the reaction zone undergo sedimentation. The settling zone may for example be conical, narrowing in the downward direction. In the at least one residence time vessel it is ensured that the laden methanol flows from the inlet to the outlet slowly so that the metal sulfides formed in the reaction zone can undergo sedimentation in the settling zone largely unhindered. The first suspension accumulating in the settling zone is subsequently supplied to the treatment vessel from the outlet of the residence time vessel.

A preferred embodiment of the process according to the invention is characterized in that the first suspension is supplied to the treatment vessel from at least two separate residence time vessels.

The metal carbonyls present in the gas mixture are especially iron carbonyls and nickel carbonyls. Iron and nickel carbonyls have markedly different solubilities in methanol. Iron carbonyls have an approximately 100 times higher solubility than nickel carbonyls. Consequently the iron carbonyls may advantageously already be removed with the so-called prewash methanol in the absorber or the absorption column. The prewash methanol is used especially for removal of HCN and further trace constituents (such as for example carbonyl sulfide) from the gas mixture. Nickel carbonyls are advantageously removed in a separate circuit with the methanol of the absorption column used especially for removal of H₂S (desulfurization) from the gas mixture. In this process mode it has accordingly proven advantageous to precipitate the iron and nickel carbonyls as iron and nickel sulfides in separate residence time vessels. The first suspension is accordingly supplied to the treatment vessel from at least two separate residence time vessels. The first suspension is thus to be understood as meaning a suspension comprising metal sulfides and laden methanol, wherein this first suspension contains primarily nickel sulfide in one case and primarily iron sulfide in another case.

A preferred embodiment of the process according to the invention is therefore characterized in that the first suspension comprises substantially iron sulfides in a first of the at least two separate residence time vessels and the first suspension comprises substantially nickel sulfides in a second of the at least two separate residence time vessels.

The term “substantially” is thus to be understood as meaning that the first suspension of the first residence time vessel comprises at least 90% by weight of iron sulfide based on the total amount of metal sulfides in the first residence time vessel, particularly preferably at least 95% by weight and more preferably at least 97.5% by weight. The first suspension of the second residence time vessel comprises at least 95% by weight of nickel sulfide based on the total amount of metal sulfides in the second residence time vessel, preferably at least 99% by weight, particularly preferably at least 99.5% by weight. Here “iron sulfide” and “nickel sulfide” are to be understood as meaning all conceivable sulfide compounds of iron and nickel, for example iron sulfide may comprise both iron(II) sulfide and iron(Ill) sulfide.

Typical residence times of the nickel carbonyls for complete conversion to nickel sulfide and sedimentation in the reaction and settling zone of the residence time vessel are 5 to 80 minutes, preferably 15 to 60 minutes. Typical residence times of the iron carbonyls for complete conversion to iron sulfide and sedimentation in the reaction and settling zone of the residence time vessel are 1 to 16 hours, preferably at least 3 hours.

A preferred embodiment of the process according to the invention is characterized in that a feed from the first residence time vessel to the treatment vessel is arranged above a feed from the second residence time vessel to the treatment vessel.

In particular the feed from the first residence time vessel to the treatment vessel arranged above the feed from the second residence time vessel is used to supply the first suspension comprising primarily iron sulfides to the treatment vessel. The feed from the second residence time vessel to the treatment vessel arranged below the feed from the first residence time vessel to the treatment vessel is used to supply the first suspension comprising primarily nickel sulfides to the treatment vessel. Thus in this case the treatment vessel comprises two spatially separate feed ports for the first suspension comprising predominantly iron sulfide and the first suspension comprising predominantly nickel sulfide, wherein the port for supplying the first suspension comprising predominantly iron sulfide is arranged above the port for supplying the first suspension comprising predominantly nickel sulfide. In addition, the port for supplying the water vapor is arranged below the abovementioned ports.

In respect of the iron sulfide this allows for a longer-duration mass transfer and heat exchange with the water vapor which is applied in a lower region or bottom region of the treatment vessel and traverses the treatment vessel from bottom to top. The first suspension traverses the treatment vessel from top to bottom.

Studies have shown that nickel sulfide can be easier than iron sulfide to “transprecipitate” from methanol into water. In other words a methanol suspension comprising nickel sulfide more easily forms large aggregates—which undergo sedimentation readily—upon contact with water vapor than is the case for iron sulfides. It is therefore advantageous to provide the iron sulfides with longer-duration contact with water vapor in countercurrent so that the iron sulfides also undergo sufficient sedimentation in the second suspension.

Further studies have shown that metal carbonyls not precipitated as metal sulfides in the laden methanol are subsequently converted into metal sulfides in water, in particular upon contact with water vapor. The conversion of the nickel carbonyls to nickel sulfide thus surprisingly occurs substantially faster than the conversion of the iron carbonyls to iron sulfide. For this reason too it is advantageous to pass the first suspension comprising primarily iron sulfide and unconverted iron carbonyls into the treatment vessel above the first suspension comprising primarily nickel sulfide and unconverted nickel carbonyls so that the unconverted iron carbonyls are in contact with the water vapor flowing from bottom to top for longer than is the case for the unconverted nickel carbonyls.

A preferred embodiment of the process according to the invention is characterized in that the precipitation of the metal sulfides from the metal carbonyls present in the laden methanol is brought about by desorption of carbon monoxide (CO) from the laden methanol and/or by temperature elevation of the laden methanol.

Desorption of carbon monoxide from laden scrubbing liquid causes the equilibrium of the abovementioned exemplary reaction for forming the metal sulfides

Fe(CO)₅+H₂S [symbol] FeS⬇+5CO+H₂

to be shifted to the product side through removal of one of the reaction products (CO), thus resulting in preferential formation of the metal sulfides. The conversion of the metal carbonyls to metal sulfides is further promoted by high temperatures.

A preferred embodiment of the process according to the invention is characterized in that the desorption of the carbon monoxide (CO) is carried out in a decompression vessel by decompression (flashing) of the laden methanol.

Alternatively or in addition the desorption of the carbon monoxide may be achieved by stripping with an inert gas. Suitable stripping gases also include methanol vapor, where this then corresponds to a hot regeneration. One example of an inert stripping gas is nitrogen.

A preferred embodiment of the process according to the invention is characterized in that after the decompression the laden methanol is supplied to the at least one residence time vessel to form the first suspension in the at least one residence time vessel.

To avoid obstructions or blockages of plant components it has proven advantageous to supply the laden and depressurized methanol directly to the residence time vessel after the desorption of carbon monoxide brought about by the depressurization.

The pressure in the residence time vessel is preferably in a range of 1 to 20 bar and preferably at least 3 bar and the temperature is typically 0° C. to 150° C. and preferably at least 40° C.

A preferred embodiment of the process according to the invention is characterized in that the water vapor is supplied to the treatment vessel in a lower region of the treatment vessel, in particular is supplied in a bottom region of the treatment vessel.

This ensures that the time for mass transfer and heat exchange between the applied water vapor and the first suspension preferably applied at the top region of the treatment vessel is as long as possible.

A preferred embodiment of the process according to the invention is characterized in that the gas mixture comprises a synthesis gas, wherein the synthesis gas comprises as constituents at least hydrogen (H₂), carbon monoxide (CO), carbon dioxide (CO₂), hydrogen sulfide (H₂S) and metal carbonyls.

Further constituents that may be present include carbonyl sulfide (COS), mercaptans and/or hydrogen cyanide (HCN) in the synthesis gas. The synthesis gas optionally comprises only trace amounts, if any, of hydrogen sulfide (H₂S) or only trace amounts, if any, of carbon dioxide (CO₂).

In one example the synthesis gas comprises the constituents hydrogen (H₂), carbon monoxide (CO), carbon dioxide (CO₂) and hydrogen sulfide (H₂S), wherein hydrogen (H₂) and carbon monoxide (CO) are valuable gases not to be removed and carbon dioxide (CO₂) and hydrogen sulfide (H₂S) are acidic gas constituents to be removed. Hydrogen sulfide in particular may as a byproduct be sent for recovery to a synthesis of sulfur and under these circumstances constitutes a valuable gas. The metal carbonyls generally do not constitute product of value and after the precipitation as metal sulfides and corresponding workup are sent for disposal.

The object of the invention is further achieved by an apparatus for removal of metal carbonyls from a gas mixture in which the gas mixture is subjected to a gas scrubbing with methanol as a physical scrubbing liquid and in which the metals of the metal carbonyls are at least partially precipitable from laden methanol as metal sulfides, comprising the following constituents in fluid communication with one another:

a treatment vessel comprising means for supplying steam to the treatment vessel and means for supplying a first suspension comprising laden methanol and metal sulfides to the treatment vessel, wherein

the means for supplying the steam and the means for supplying the first suspension are arranged such that the steam and the first suspension are movable with respect to one another in countercurrent and in direct contact with mass transfer inside the treatment vessel;

means for withdrawing a gaseous product from the treatment vessel;

means for withdrawing a second suspension comprising water, methanol and metal sulfides from the treatment vessel.

A preferred embodiment of the apparatus according to the invention is characterized in that the apparatus comprises at least one residence time vessel in communication with the means for supplying the first suspension to the treatment vessel, wherein the residence time vessel comprises a reaction and settling zone for precipitating the metal sulfides from the metal carbonyls in which the first suspension is producible.

A preferred embodiment of the apparatus according to the invention is characterized in that the apparatus comprises at least two separate residence time vessels and separate means for supplying the first suspension to the treatment vessel which are in communication with the respective residence time vessels, wherein a first suspension comprising substantially iron sulfides is producible in a first residence time vessel and a first suspension comprising substantially nickel sulfides is producible in a second residence time vessel, wherein the separate means for supplying the first suspension to the treatment vessel comprise a first and a second means for supplying the first suspension to the treatment vessel, wherein the first suspension comprising substantially iron sulfides is suppliable to the treatment vessel via the first means and the first suspension comprising substantially nickel sulfides is suppliable to the treatment vessel via the second means.

It is preferable when the first means for supplying the treatment vessel is arranged above the second means.

The object of the invention is further achieved by the use of the process according to the invention or of the apparatus according to the invention in a gas scrubbing process with methanol as the scrubbing liquid for removal of metal carbonyls and hydrogen sulfide (H₂S) from a crude synthesis gas comprising at least the constituents hydrogen (H₂), carbon monoxide (CO), carbon dioxide (CO₂), hydrogen sulfide (H₂S) and metal carbonyls.

### BRIEF DESCRIPTION OF THE DRAWINGS

The invention is more particularly elucidated hereinbelow by way of examples without in any way limiting the subject matter of the invention. Further features, advantages and possible applications of the invention will be apparent from the following description of the working examples in connection with the drawings.

FIG. 1 shows a schematic diagram of a first exemplary embodiment of the process according to the invention/of the apparatus according to the invention,

FIG. 2 shows a schematic diagram of a second exemplary embodiment of the process according to the invention/of the apparatus according to the invention.

### DETAILED DESCRIPTION OF PREFERRED EMBODIMENTS

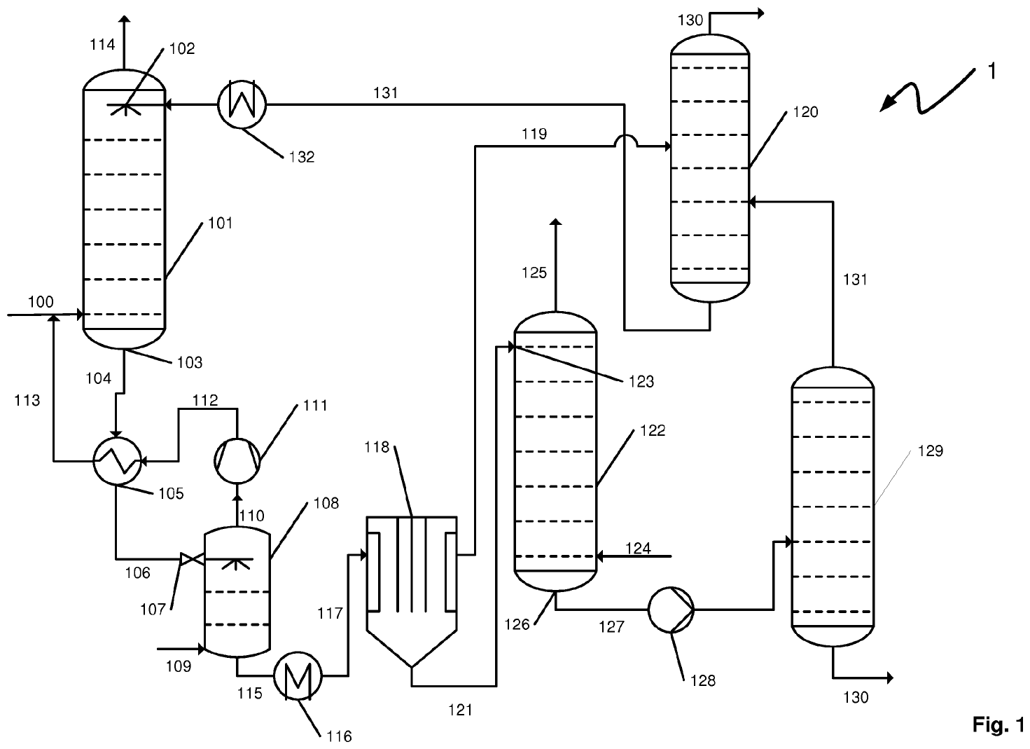

FIG. 1 is a schematic diagram of a process flow 1/an apparatus 1 for use in a plant for gas scrubbing of crude synthesis gases with methanol as the scrubbing medium according to a first working example of the invention.

Via conduit 100 an absorption column 101 is supplied at a pressure of 40 bar with a crude synthesis gas mixture containing at least the components hydrogen (H₂) and carbon monoxide (CO) as desired components and metal carbonyls, hydrogen sulfide (H₂S) and carbon dioxide (CO₂) as components to be removed. In the top region of the absorption column 101 regenerated methanol is applied via the liquid distributor 102 and flows down the absorption column in finely divided form to absorb undesired constituents from the crude synthesis gas. The crude synthesis gas traverses the absorption column 101 from bottom to top to be depleted of undesired constituents such as H₂S and CO₂ by absorption in methanol. Purified synthesis gas exits the absorption column via conduit 114. In the bottom region 103 the methanol laden inter alia with H₂S is withdrawn from the absorption column 101 via conduit 104, warmed in an indirect heat exchanger 105 and via conduit 106 and expansion valve 107 decompressed into the decompression vessel 108 to a pressure of 12 bar. The decompression gas released upward also contains CO and thus, on account of the equilibrium shift in the equilibrium reaction, metal carbonyls present in the laden methanol are converted into metal sulfides by the H₂S present in the laden methanol. To amplify the stripping of CO nitrogen is supplied as a stripping gas via the conduit 109. The gases withdrawn via the conduit 110 are recompressed to 40 bar via the compressor 111, supplied via conduit 112 to the indirect heat exchanger 105 for cooling and subsequently as a recycle gas stream, via conduit 113, combined with the crude synthesis gas stream in conduit 100. The methanol at least partially freed of CO in the decompression vessel 108 is sent via conduit 115 to an indirect heat exchanger 116 and warmed before being sent via conduit 117 to the residence time vessel 118.

Formation of metal sulfides from the metal carbonyls is favored by stripping of CO in the decompression vessel 108 and additional warming of the laden methanol in the indirect heat exchanger 116. The residence time vessel 118 has a reaction zone and a settling zone. The laden methanol is passed through the reaction zone for as long as required for complete precipitation of the metal sulfides. The precipitated metal sulfides then pass into the settling zone which as illustrated in the example of the residence time vessel 118 is configured as a conical bottom in which the metal sulfides and a proportion of the laden methanol accumulate as the first suspension. The larger part of the laden methanol, i.e. the supernatant containing only a small proportion of sulfides, if any, is withdrawn from the residence time vessel via conduit 119 and sent to column 120 for hot regeneration. The sulfide sludge, the first suspension containing the smaller part of the laden methanol and metal sulfides, is supplied via conduit 121 to treatment vessel 122 at a pressure of 10 bar and a temperature of 90° C. The first suspension traverses the treatment vessel 122 from top to bottom after application via port 123. Treatment vessel 122 is simultaneously supplied via conduit 124 with water vapor at a pressure of 8 bar and a temperature of 283° C. Water vapor traverses treatment vessel 122 from bottom to top so that the first suspension and the water vapor are in direct contact in countercurrent, thus allowing mass transfer and heat exchange between the water vapor and the first suspension. Due to the mass transfer and heat exchange between the first suspension and the water vapor the metal sulfides pass into the aqueous phase, i.e. are “transprecipitated” into the aqueous phase and therein form larger agglomerates which have a stronger sedimentation propensity than metal sulfides of the methanolic suspension (first suspension). Water vapor from conduit 124 is used to strip hydrogen sulfide from the laden methanol supplied via conduit 121. The stripped hydrogen sulfide exits treatment vessel 122 via conduit 125 as a gaseous product.

The internals in vessel 122 and column 129 indicated in the figure are to be understood as being merely schematic. Based on their knowledge of the art or based on routine experiments those skilled in the art will be able to select internals which not only ensure satisfactory mass transfer between the phases involved but also enable passage of a suspension without an excessive propensity for blockage.

In addition to hydrogen sulfide the gaseous product in conduit 125 also contains vaporous methanol obtained on account of the heat transfer of the water vapor to the laden methanol of the first suspension. Gaseous product in conduit 125 which has a pressure of 6.5 bar and a temperature of 129° C. is subsequently subjected to a multistage process for removal by condensation of the vaporous methanol (not shown). The obtained product comprising primarily hydrogen sulfide, also referred to as Claus gas, is subsequently sent to a Claus plant for production of sulfur.

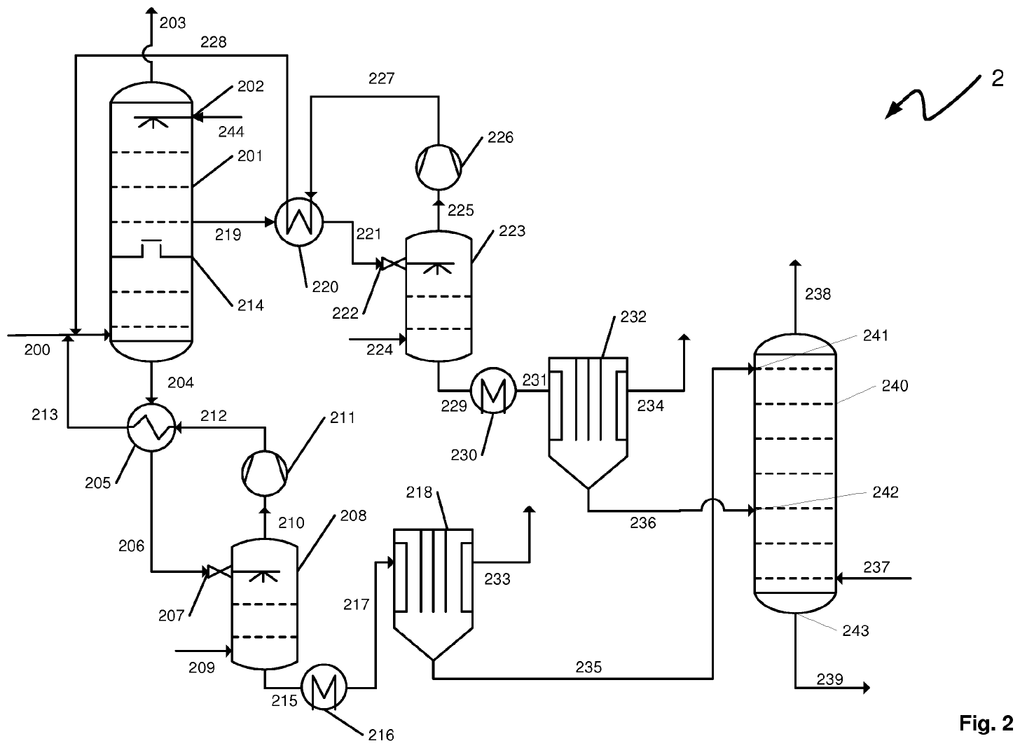

At a pressure of 7 bar and a temperature of 143° C. the second suspension comprising water, methanol and metal sulfides is sent from the bottom region 126 of the treatment vessel 122 via conduit 127 to a rectification column 129 using pump 128. A thermal removal of the methanol from the second suspension is carried out in rectification column 129. Obtained as the bottoms product is a sulfide sludge composed of metal sulfides and water which is withdrawn via conduit 130 and sent for disposal. Withdrawn at the top of the rectification column 129 is methanol which is sent via conduit 131 to the column 120 for hot regeneration. The gases obtained in the hot regeneration are withdrawn via conduit 133 and worked up similarly to the gaseous product withdrawn in conduit 125. Hot regenerated methanol exits column 120 via conduit 131 and after cooling in the indirect heat exchanger 132 is sent to the absorption column 101 for reabsorption of undesired constituents of the crude synthesis gas FIG. 2 is a schematic diagram of a process flow 2/an apparatus 2 for use in a plant for gas scrubbing of crude synthesis gases with methanol as the scrubbing medium according to a second working example of the invention.

Via the conduit 200 an absorption column 201 is supplied at a pressure of 40 bar with a crude synthesis gas mixture containing at least the components hydrogen (H₂) and carbon monoxide (CO) as desired components and metal carbonyls, hydrogen sulfide (H₂S) and carbon dioxide (CO₂) as components to be removed. In the top region of the absorption column 201 regenerated methanol is applied via conduit 244 and liquid distributor 202 and falls down the absorption column 201 in finely divided form to absorb undesired constituents from the crude synthesis gas. The crude synthesis gas traverses the absorption column 201 from bottom to top. Purified synthesis gas exits the absorption column via conduit 203.

Absorption column 201 comprises at least a so-called prewash region and a region for desulfurization. The lower prewash region serves primarily for removal of hydrogen cyanide (HCN), further trace constituents such as carbonyl sulfide (COS) and hydrogen sulfide (H₂S). The upper region serves primarily for desulfurization, i.e. removal of hydrogen sulfide (H₂S), and removal of carbon dioxide (CO₂). Both regions are separated from one another by a gas-permeable chimney tray 214.

Withdrawn from the lower prewash region via conduit 204 is methanol laden primarily with H₂S and HCN which on account of the metal carbonyl-specific better solubility of iron carbonyls compared to nickel carbonyls in methanol contains primarily iron carbonyls. The methanol laden primarily with H₂S, HCN and iron carbonyls is warmed in the indirect heat exchanger 205 and via conduit 206 and expansion valve 207 decompressed into the decompression vessel 208 to a pressure of 12 bar. The decompression gas released also contains CO and thus, on account of the equilibrium shift of the equilibrium reaction, iron carbonyls present in the laden methanol are converted into iron sulfides by the H₂S present in the laden methanol. To amplify the stripping of CO nitrogen is supplied as a stripping gas via the conduit 209. The gases withdrawn via conduit 210 are recompressed to 40 bar via compressor 211, supplied via conduit 212 to the indirect heat exchanger 205 for cooling and subsequently as a recycle gas stream, via conduit 213, combined with the crude synthesis gas stream in conduit 200. The methanol at least partially freed of CO in the decompression vessel 208 is sent via conduit 215 to an indirect heat exchanger 216, warmed in heat exchanger 216 and then sent via conduit 217 to the residence time vessel 218.

Withdrawn from the upper region of the absorption column 201 serving for desulfurization via conduit 219 is a methanol laden with H₂S and CO₂ which on account of the metal carbonyl-specific poorer solubility in methanol of nickel carbonyls compared to iron carbonyls contains primarily nickel carbonyls. The methanol laden primarily with H₂S, CO₂ and nickel carbonyls is warmed in the indirect heat exchanger 220 and via conduit 221 and expansion valve 222 decompressed into the decompression vessel 223 to a pressure of 12 bar. The decompression gas released also contains CO and thus, on account of the equilibrium shift, nickel carbonyls present in the laden methanol are converted into nickel sulfides by the H₂S present in the laden methanol. To amplify the stripping of CO nitrogen is supplied as a stripping gas via conduit 224. The gases withdrawn via the conduit 225 are recompressed to 40 bar via compressor 226, supplied via conduit 227 to the indirect heat exchanger 220 for cooling and subsequently as a recycle gas stream, via conduit 228, combined with the crude synthesis gas stream in conduit 200. The methanol at least partially freed of CO in decompression vessel 223 is sent via conduit 229 to an indirect heat exchanger 230, warmed in heat exchanger 230 and then sent via conduit 231 to the residence time vessel 232.

Formation of iron or nickel sulfide from the respective metal carbonyls is favored by stripping of CO in the decompression vessels 208 and 223 and additional warming of the respective laden methanol in the indirect heat exchangers 216 and 230. Residence time vessels 218 and 232 each have a reaction zone and a settling zone. Laden methanol is passed through the reaction zone for as long as required for largely complete precipitation of the respective metal sulfide. The residence time is about 4 hours in the case of iron sulfide and about 50 minutes in the case of nickel sulfide. The precipitated metal sulfides then pass into the respective settling zones of the residence time vessels 218 and 232 which as shown in the example of FIG. 2 are configured as conical bottoms in which the respective metal sulfides and a proportion of the laden methanol accumulate as the first suspension. The larger part of the laden methanol, i.e. the supernatant containing only a very small proportion of metal sulfides, if any, is withdrawn from the residence time vessels 218, 232 via the conduits 233 and 234 and sent to a column for hot regeneration (not shown).

The sulfide sludge from the residence time vessel 218, i.e. the first suspension containing part of the laden methanol and in this case primarily iron sulfide, is supplied via conduit 235 to treatment vessel 240 at a pressure of 10 bar and a temperature of 90° C. The first suspension from residence time vessel 218 traverses the treatment vessel from top to bottom after application via port 241. The sulfide sludge from the residence time vessel 232, the first suspension containing part of the methanol and in this case primarily nickel sulfide, is simultaneously supplied via conduit 236 to treatment vessel 240 at a pressure of 10 bar and a temperature of 90° C.

The feed of the conduit 235 from the residence time vessel 218 to the treatment vessel 240 is arranged above the feed of the conduit 236 from the residence time vessel 232 to the treatment vessel 240. Based on the total amount of metal sulfides in the residence time vessel 218 the first suspension from residence time vessel 218 contains substantially iron sulfides. Based on the total amount of metal sulfides in the residence time vessel 232 the first suspension from residence time vessel 232 contains substantially nickel sulfides.

In addition to the supply of the first suspensions from the residence time vessels 218 and 232 treatment vessel 240 is supplied via conduit 237 with water vapor at a pressure of 8 bar and a temperature of 283° C. Water vapor traverses the treatment vessel from bottom to top so that the first suspensions from the residence time vessels 218, 232 and the water vapor are in direct contact in countercurrent, thus allowing mass transfer and heat exchange between the water vapor and the first suspensions.

Due to the mass transfer and heat exchange between the first suspensions and the water vapor the metal sulfides pass into the aqueous phase, i.e. are transprecipitated into the aqueous phase and therein form larger agglomerates which have a stronger sedimentation propensity than metal sulfides in methanolic suspension (first suspension).

The feed ports 241, 242 of the conduits 235 and 236 to the treatment vessel 240 are arranged such that the first suspension comprising substantially iron sulfide from residence time vessel 218 is in direct contact with water vapor from conduit 237 for longer than is the case for the first suspension comprising substantially nickel sulfide from residence time vessel 232. In the example shown the feed port of the conduit 235 is for this reason arranged above the feed port of the conduit 236 so that the port 241 is likewise arranged above the port 242. In terms of height arrangement the ports 241, 242 are the same level as the respective feeds of the conduits 235, 236.

Water vapor from conduit 237 is used to strip hydrogen sulfide from the laden methanol. Stripped hydrogen sulfide exits treatment vessel 240 via conduit 238. In addition to hydrogen sulfide the gaseous product in conduit 238 also contains vaporous methanol obtained on account of the heat transfer of the water vapor to the laden methanol of the first suspension. Gaseous product in conduit 238 which has a pressure of 6.5 bar and a temperature of 129° C. is subsequently subjected to a multistage process for removal by condensation of the vaporous methanol (not shown). The obtained product comprising primarily hydrogen sulfide, also referred to as Claus gas, may subsequently be sent to a Claus plant for production of sulfur.

At a pressure of 7 bar and a temperature of 143° C. the second suspension comprising water, methanol and metal sulfides is sent from the bottom region 243 of the treatment vessel 240 via conduit 239 to a rectification column (not shown) analogously to the example from FIG. 1. Analogously to the example according to FIG. 1 a thermal separation of the methanol from the second suspension is carried out in the rectification column. Obtained as the bottoms product is a sulfide sludge composed of metal sulfides and water which is withdrawn from the rectification column and sent for disposal. Workup of the tops product from the rectification is carried out analogously to the example according to FIG. 1. Hot regenerated methanol is finally supplied to the absorption column 201 via conduit 244 and liquid distributor 202 and reused for absorption of undesired constituents from crude synthesis gas.

Embodiments of the invention are described with reference to different types of subject matter. In particular, certain embodiments are described with reference to process claims while other embodiments are described with reference to apparatus claims. However, it will be apparent to a person skilled in the art from the description hereinabove and hereinbelow that unless otherwise stated in addition to any combination of features belonging to a type of subject matter any combination of features relating to different types of subject matter may also be contemplated. All features may be combined to achieve synergistic effects which go beyond simple summation of the technical features.

While the invention was represented and described in detail in the drawings and the preceding description, such representation and description shall be considered elucidatory or exemplary and non-limiting. The invention is not limited to the disclosed embodiments. Other variations of the disclosed embodiments may be understood and carried out by those skilled in the art of the field of the claimed invention through study of the drawings, the disclosure and the dependent claims.

In the claims the word “comprising” does not exclude further elements or steps and the indefinite article “a” does not exclude a plurality. Reference numerals in the claims should not be interpreted as limiting the scope of the claims.

### LIST OF REFERENCE NUMERALS

1, 2 Inventive process or apparatus
100 Conduit
101 Absorption column
102 Liquid distributor
103 Bottom region of the absorption column
104 Conduit
105 Indirect heat exchanger
106 Conduit
107 Expansion valve
108 Decompression vessel
109 Conduit
110 Conduit
111 Compressor
112 Conduit
113 Conduit
114 Conduit
115 Conduit
116 Indirect heat exchanger
117 Conduit
118 Residence time vessel
119 Conduit
120 Column for hot regeneration
121 Conduit
122 Treatment vessel
123 Port
124 Conduit
125 Conduit
126 Bottom region of treatment vessel
127 Conduit
128 Pump
129 Rectification column
130 Conduit
131 Conduit
132 Indirect heat exchanger
133 Conduit
200 Conduit
201 Absorption column
202 Liquid distributor
203 Conduit
204 Conduit
205 Indirect heat exchanger
206 Conduit
207 Expansion valve
208 Decompression vessel
209 Conduit
210 Conduit
211 Compressor
212 Conduit
213 Conduit
214 Chimney tray
215 Conduit
216 Indirect heat exchanger
217 Conduit
218 Residence time vessel
219 Conduit
220 Indirect heat exchanger
221 Conduit
222 Expansion valve
223 Decompression vessel
224 Conduit
225 Conduit
226 Compressor
227 Conduit
228 Conduit
229 Conduit
230 Indirect heat exchanger
231 Conduit
232 Residence time vessel
233 Conduit
234 Conduit
235 Conduit
236 Conduit
237 Conduit
238 Conduit
239 Conduit
240 Treatment vessel
241 Port
242 Port
243 Bottom region of treatment vessel
244 Conduit

1.-19. (canceled)

20. A process for removal of metal carbonyls from a gas mixture in which the gas mixture is subjected to a gas scrubbing in an absorber with methanol as the physical scrubbing liquid to obtain laden methanol and in which the metals of the metal carbonyls are at least partially precipitated from the laden methanol as metal sulfides to obtain a first suspension which comprises the metal sulfides and at least a proportion of the laden methanol and the first suspension is sent to a treatment vessel, wherein the first suspension is brought into direct contact with water vapor in countercurrent in the treatment vessel to obtain a second suspension comprising at least water, methanol and metal sulfides and a gaseous product and the second suspension and the gaseous product are withdrawn from the treatment vessel as separate streams.

21. The process according to claim 20, wherein the first suspension comprising a proportion of the laden methanol is sent to the treatment vessel and the remainder of the laden methanol is sent to a regeneration.

22. The process according to claim 20, wherein the gaseous product comprises a mixture of hydrogen sulfide (H₂S) and methanol vapor.

23. The process according to claim 22, wherein methanol is condensed out of the methanol vapor of the gaseous product and the remaining hydrogen sulfide (H₂S) is sent to a Claus plant for further processing.

24. The process according to claim 20, wherein the gaseous product is withdrawn from a top region of the treatment vessel and/or the second suspension is withdrawn from a bottom region of the treatment vessel.

25. The process according to claim 20, wherein the second suspension is supplied to a distillation to obtain substantially pure methanol as the tops product and a mixture comprising substantially metal sulfides and water as the bottoms product.

26. The process according to claim 20, wherein the first suspension is supplied to the treatment vessel from at least one residence time vessel.

27. The process according to claim 20, wherein the first suspension is supplied to the treatment vessel from at least two separate residence time vessels.

28. The process according to claim 27, wherein the first suspension comprises substantially iron sulfides in a first of the at least two separate residence time vessels and the first suspension comprises substantially nickel sulfides in a second of the at least two separate residence time vessels.

29. The process according to claim 28, wherein a feed from the first residence time vessel to the treatment vessel is arranged above a feed from the second residence time vessel to the treatment vessel.

30. The process according to claim 20, wherein the precipitation of the metal sulfides from the metal carbonyls present in the laden methanol is brought about by desorption of carbon monoxide (CO) from the laden methanol and/or by temperature elevation of the laden methanol.

31. The process according to claim 30, wherein the desorption of the carbon monoxide (CO) is carried out in a decompression vessel by decompression (flashing) of the laden methanol.

32. The process according to claim 31 wherein after the decompression the laden methanol is supplied to the at least one residence time vessel to form the first suspension in the at least one residence time vessel.

33. The process according to claim 20, wherein the water vapor is supplied to the treatment vessel in a lower region of the treatment vessel.

34. The process according to claim 20, wherein the gas mixture comprises a synthesis gas, wherein the synthesis gas comprises as constituents at least hydrogen (H₂), carbon monoxide (CO), carbon dioxide (CO₂), hydrogen sulfide (H₂S) and metal carbonyls.

35. An apparatus for removal of metal carbonyls from a gas mixture in which the gas mixture is subjected to a gas scrubbing with methanol as a physical scrubbing liquid and in which the metals of the metal carbonyls are at least partially precipitable from laden methanol as metal sulfides, comprising the following constituents in fluid communication with one another:
a treatment vessel comprising
a means for supplying steam to the treatment vessel and
a means for supplying a first suspension comprising laden methanol and metal sulfides to the treatment vessel, wherein
the means for supplying the steam and the means for supplying the first suspension are arranged such that the steam and the first suspension are movable with respect to one another in countercurrent and in direct contact with mass transfer inside the treatment vessel;
a means for withdrawing a gaseous product from the treatment vessel;
a means for withdrawing a second suspension comprising water, methanol and metal sulfides from the treatment vessel.

36. The apparatus according to claim 35, further comprising at least one residence time vessel in communication with the means for supplying the first suspension to the treatment vessel, wherein the residence time vessel comprises a reaction and settling zone for precipitating the metal sulfides from the metal carbonyls in which the first suspension is producible.

37. The apparatus according to claim 36, further comprising at least two separate residence time vessels and separate means for supplying the first suspension to the treatment vessel which are in communication with the respective residence time vessels, wherein a first suspension comprising substantially iron sulfides is producible in a first residence time vessel and a first suspension comprising substantially nickel sulfides is producible in a second residence time vessel, wherein the separate means for supplying the first suspension to the treatment vessel comprise a first and a second means for supplying the first suspension to the treatment vessel, wherein the first suspension comprising substantially iron sulfides is suppliable to the treatment vessel via the first means and the first suspension comprising substantially nickel sulfides is suppliable to the treatment vessel via the second means, wherein the first means for supplying the treatment vessel is arranged above the second means.
